(19) United States
(12) Patent Application Publication
(10) Pub. No.: US 2003/0132950 A1
(43) Pub. Date: Jul. 17, 2003

(54) Detecting, classifying, and interpreting input events based on stimuli in multiple sensory domains

(76) Inventors: Fahri Surucu, Fremont, CA (US); Carlo Tomasi, Palo Alto, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/187,032

(22) Filed: Jun. 28, 2002

Related U.S. Application Data
(60) Provisional application No. 60/337,086, filed on Nov. 27, 2001.

(51) Int. Cl. G09G 5/00

(52) U.S. Cl. 345/700

(57) ABSTRACT

Stimuli in two or more sensory domains, such as an auditory domain and a visual domain, are combined in order to improve reliability and accuracy of detected user input. Detected events that occur substantially simultaneously in the multiple domains are deemed to represent the same user action, and if interpretable as a coherent action and provided to the system as interpreted input. The invention is applicable, for example, in a virtual keyboard or virtual controller, where stimuli resulting from user actions are detected, interpreted, and provided as input to a system.

### CROSS-REFERENCE TO RELATED APPLICATIONS

The present application claims priority under 35 U.S.C. §119(e) from U.S. Provisional Patent Application Serial No. 60/337,086 for “Sound-Based Method and Apparatus for Detecting the Occurrence and Force of Keystrokes in Virtual Keyboard Applications,” filed Nov. 27, 2001, the disclosure of which is incorporated herein by reference.

The present application is related to U.S. patent application Ser. No. 09/502,499 for “Method and Apparatus for Entering Data Using a Virtual Input Device,” filed Feb. 11, 2000, the disclosure of which is incorporated herein by reference.

The present application is further related to U.S. patent application Ser. No. 10/115,357 for “Method and Apparatus for Approximating a Source Position of a Sound-Causing Event for Determining an Input Used in Operating an Electronic Device,” filed Apr. 2, 2002, the disclosure of which is incorporated herein by reference.

The present application is further related to U.S. patent application Ser. No. 09/948,508 for “Quasi-Three-Dimensional Method and Apparatus To Detect and Localize Interaction of User-Object and Virtual Transfer Device,” filed Sep. 7, 2001, the disclosure of which is incorporated herein by reference.

### BACKGROUND OF THE INVENTION

1. Field of the Invention

The present invention is related to detecting, classifying, and interpreting input events, and more particularly to combining stimuli from two or more sensory domains to more accurately classify and interpret input events representing user actions.

2. Description of the Background Art

It is often desirable to use virtual input devices to input commands and/or data to electronic devices such as, for example personal digital assistants (PDAs), cell phones, pagers, musical instruments, and the like. Given the small size of many of these devices, inputting data or commands on a miniature keyboard, as is provided by some devices, can be time consuming and error prone. Alternative input methods, such as the Graffiti® text input system developed by Palm, Inc., of Santa Clara, Calif., do away with keyboards entirely, and accept user input via a stylus. Such schemes are, in many cases, slower and less accurate than typing on a conventional full-sized keyboard. Add-on keyboards may be available, but these are often cumbersome or impractical to attach when needed, or are simply too large and heavy for users to carry around.

For many applications, virtual keyboards provide an effective solution to this problem. In a virtual keyboard system, a user taps on regions of a surface with his or her fingers or with another object such as a stylus, in order to interact with an electronic device into which data is to be entered. The system determines when a user's fingers or stylus contact a surface having images of keys (“virtual keys”), and further determines which fingers contact which virtual keys thereon, so as to provide input to a PDA (or other device) as though it were conventional keyboard input. The keyboard is virtual, in the sense that no physical device need be present on the part of surface that the user contacts, henceforth called the typing surface.

A virtual keyboard can be implemented using, for example, a keyboard guide: a piece of paper or other material that unfolds to the size of a typical keyboard, with keys printed thereon to guide the user's hands. The physical medium on which the keyboard guide is printed is simply a work surface and has no sensors or mechanical or electronic component. The input to the PDA (or other device) does not come from the keyboard guide itself, but rather is based on detecting contact of the user's fingers with areas on the keyboard guide. Alternatively, a virtual keyboard can be implemented without a keyboard guide, so that the movements of a user's fingers on any surface, even a plain desktop, are detected and interpreted as keyboard input. Alternatively, an image of a keyboard may be projected or otherwise drawn on any surface (such as a desktop) that is defined as the typing surface or active area, so as to provide finger placement guidance to the user. Alternatively, a computer screen or other display may show a keyboard layout with icons that represent the user's fingers superimposed on it. In some applications, nothing is projected or drawn on the surface.

Camera-based systems have been proposed that detect or sense where the user's fingers are relative to a virtual keyboard. For example, U.S. Pat. No. 5,767,842 to Korth, entitled “Method and Device Optical Input of Commands or Data,” issued Jun. 16, 1998, describes an optical user interface which uses an image acquisition system to monitor the hand and finger motions and gestures of a human user, and interprets these actions as operations on a physically non-existent computer keyboard or other input device.

U.S. Pat. No. 6,323,942 to Bamji, entitled “CMOS-compatible three-dimensional image sensor IC,” issued Nov. 27, 2001, describes a method for acquiring depth information in order to observe and interpret user actions from a distance.

U.S. Pat. No. 6,283,860 to Lyons et al., entitled “Method, System, and Program for Gesture Based Option Selection,” issued Sep. 4, 2001, describes a system that displays, on a screen, a set of user-selectable options. The user standing in front of the screen points at a desired option and a camera of the system takes an image of the user while pointing. The system calculates from the pose of the user in the image whether the user is pointing to any of the displayed options. If such is the case, that particular option is selected and an action corresponding with that option is executed.

U.S. Pat. No. 6,191,773 to Maruno et al., entitled “Interface Apparatus,” issued Feb. 20, 2001, describes an interface for an appliance having a display, including recognizing the shape or movement of an operator's hand, displaying the features of the shape or movement of the hand, and controlling the displayed information, wherein the displayed information can be selected, indicated or moved only by changing the shape or moving the hand.

U.S. Pat. No. 6,252,598 to Segen, entitled “Video Hand Image Computer Interface,” issued Jun. 26, 2001, describes an interface using video images of hand gestures. A video signal having a frame image containing regions is input to a processor. A plurality of regions in the frame are defined and screened to locate an image of a hand in one of the regions. The hand image is processed to locate extreme curvature values, such as peaks and valleys, corresponding to predetermined hand positions and gestures. The number of peaks and valleys are then used to identify and correlate a predetermined hand gesture to the hand image for effectuating a particular computer operation or function.

U.S. Pat. No. 6,232,960 to Goldman, entitled “Data Input Device,” issued May 15, 2001, describes a data entry device including a plurality of sensing devices worn on a user's fingers, and a flat light-weight keypad for transmitting signals indicative of data entry keyboard functions to a computer or other data entry device. The sensing devices include sensors that are used to detect unique codes appearing on the keys of the keypad or to detect a signal, such as a radar signal, generated by the signal-generating device mounted to the keypad. Pressure sensitive switches, one associated with each finger, contain resistive elements and optionally sound generating means and are electrically connected to the sensors so that when the switches are pressed they activate a respective sensor and also provide a resistive force and sound comparable to keys of a conventional keyboard.

U.S. Pat. No. 6,115,482, to Sears et al., entitled “Voice Output Reading System with Gesture Based Navigation,” issued Sep. 5, 2000, describes an optical-input print reading device with voice output for people with impaired or no vision. The user provides input to the system via hand gestures. Images of the text to be read, on which the user performs finger- and hand-based gestural commands, are input to a computer, which decodes the text images into their symbolic meanings through optical character recognition, and further tracks the location and movement of the hand and fingers in order to interpret the gestural movements into their command meaning. In order to allow the user to select text and align printed material, feedback is provided to the user through audible and tactile means. Through a speech synthesizer, the text is spoken audibly. For users with residual vision, visual feedback of magnified and image enhanced text is provided.

U.S. Pat. No. 6,204,852, to Kumar et al., entitled “Video Hand Image Three-Dimensional Computer Interface,” issued Mar. 20, 2001, describes a video gesture-based three-dimensional computer interface system that uses images of hand gestures to control a computer and that tracks motion of the user's hand or an elongated object or a portion thereof in a three-dimensional coordinate system with five degrees of freedom. During operation of the system, hand images from cameras are continually converted to a digital format and input to a computer for processing. The results of the processing and attempted recognition of each image are then sent to an application or the like executed by the computer for performing various functions or operations. When the computer recognizes a hand gesture as a “point” gesture with one finger extended, the computer uses information derived from the images to track three-dimensional coordinates of the extended finger of the user's hand with five degrees of freedom. The computer utilizes two-dimensional images obtained by each camera to derive three-dimensional position (in an x, y, z coordinate system) and orientation (azimuth and elevation angles) coordinates of the extended finger.

U.S. Pat. No. 6,002,808, to Freeman, entitled “Hand Gesture Control System,” issued Dec. 14, 1999, describes a system for recognizing hand gestures for the control of computer graphics, in which image moment calculations are utilized to determine an overall equivalent rectangle corresponding to hand position, orientation and size, with size in one embodiment correlating to the width of the hand.

These and other systems use cameras or other light-sensitive sensors to detect user actions to implement virtual keyboards or other input devices. Such systems suffer from some shortcomings that limit both their reliability and the breadth of applications where the systems can be used. First, the time at which a finger touches the surface can be determined only with an accuracy that is limited by the camera's frame rate. For instance, at 30 frames per second, finger landfall can be determined only to within 33 milliseconds, the time that elapses between two consecutive frames. This may be satisfactory for certain applications, but in some cases may introduce an unacceptable delay, for example in the case of a musical instrument.

A second limitation of such systems is that it is often difficult to distinguish gestures made intentionally for the purpose of communication with the device from involuntary motions, or from motions made for other purposes. For instance, in a virtual keyboard, it is often difficult to distinguish, using images alone whether a particular finger has approached the typing surface in order to strike a virtual key, or merely in order to rest on the typing surface, or perhaps has just moved in sympathy with another finger that was actually striking a virtual key. When striking a virtual key, other fingers of the same hand often move down as well, and because they are usually more relaxed than the finger that is about to strike the key, they can bounce down and come in very close proximity with the typing surface, or even come in contact with it. In a camera-based system, two fingers may be detected touching the surface, and the system cannot tell whether the user intended to strike one key or to strike two keys in rapid succession. In addition, typists often lower their fingers onto the keyboard before they start typing. Given the limited frame rate of a camera-based system, it may be difficult to distinguish such motion of the fingers from a series of intended keystrokes.

Similarly, another domain in which user actions are often misinterpreted is virtual controls. Television sets, stereophonic audio systems, and other appliances are often operated through remote controls. In a vehicle, the radio, compact disc player, air conditioner, or other device are usually operated through buttons, levers, or other manual actuators. For some of these applications, it may be desirable to replace the remote control or the manual actuators with virtual controls. A virtual control is a sensing mechanism that interprets the gestures of a user in order to achieve essentially the same function of the remote control or manual actuator, but without requiring the user to hold or touch any physical device. It is often difficult for a virtual control device to determine when the user actually intends to communicate with the device.

For example, a virtual system using popup menus can be used to navigate the controls of a television set in a living room. To scroll down a list, or to move to a different menu, the user would point to different parts of the room, or make various hand gestures. If the room inhabitants are engaged in a conversation, they are likely to make hand gestures that look similar to those used for menu control, without necessarily intending to communicate with the virtual control. The popup menu system does not know the intent of the gestures, and may misinterpret them and perform undesired actions in response.

As another example, a person watching television in a living room may be having a conversation with someone else, or be moving about to lift a glass, grasp some food, or for other purposes. If a gesture-based television remote control were to interpret every user motion as a possible command, it would execute many unintended commands, and could be very ineffective.

A third limitation of camera-based input systems is that they cannot determine the force that a user applies to a virtual control, such as a virtual key. In musical applications, force is an important parameter. For instance, a piano key struck gently ought to produce a softer sound than one struck with force. Furthermore, for virtual keyboards used as text input devices, a lack of force information can make it difficult or impossible to distinguish between a finger that strikes the typing surface intentionally and one that approaches it or even touches it without the user intending to do so.

Systems based on analyzing sound information related to user input gestures can address some of the above problems, but carry other disadvantages. Extraneous sounds that are not intended as commands could be misinterpreted as such. For instance, if a virtual keyboard were implemented solely on the basis of sound information, any unintentional taps on the surface providing the keyboard guide, either by the typist or by someone else, might be interpreted as keystrokes. Also, any other background sound, such as the drone of the engines on an airplane, might interfere with such a device.

What is needed is a virtual control system and methodology that avoids the above-noted limitations of the prior art. What is further needed is a system and method that improves the reliability of detecting, classifying, and interpreting input events in connection with a virtual keyboard. What is further needed is a system and method that is able to distinguish between intentional user actions and unintentional contact with a virtual keyboard or other electronic device.

### SUMMARY OF THE INVENTION

The present invention combines stimuli detected in two or more sensory domains in order to improve performance and reliability in classifying and interpreting user gestures. Users can communicate with devices by making gestures, either in the air, or in proximity with passive surfaces or objects, and not especially prepared for receiving input. By combining information from stimuli detected in two or more domains, such as auditory and visual stimuli, the present invention reduces the ambiguity of perceived gestures, and provides improved determination of time and location of such user actions. Sensory input are correlated in time and analyzed to determine whether an intended command gesture or action occurred. Domains such as vision and sound are sensitive to different aspects of ambient interference, so that such combination and correlation substantially increases the reliability of detected input.

In one embodiment, the techniques of the present invention are implemented in a virtual keyboard input system. A typist may strike a surface on which a keyboard pattern is being projected. A virtual keyboard, containing a keystroke detection and interpretation system, combines images from a camera or other visual sensor with sounds detected by an acoustic sensor, in order to determine with high accuracy and reliability whether, when, and where a keystroke has occurred. Sounds are measured through an acoustic or piezoelectric transducer, intimately coupled with the typing surface. Detected sounds may be generated by user action such as, for example, taps on the typing surface, fingers or other styluses sliding on the typing surface, or by any other means that generate a sound potentially having meaning in the context of the device or application.

Detected sounds (signals) are compared with reference values or waveforms. The reference values or waveforms may be fixed, or recorded during a calibration phase. The sound-based detection system confirms keystrokes detected by the virtual keyboard system when the comparison indicates that the currently detected sound level has exceeded the reference signal level. In addition, the sound-based detection system can inform the virtual keyboard system of the exact time of occurrence of the keystroke, and of the force with which the user's finger, stylus, or other object hit the surface during the keystroke. Force may be determined, for example, based on the amplitude, or by the strength of attack, of the detected sound. In general, amplitude, power, and energy of sound waves sensed by the sound-based detection system are directly related to the energy released by the impact between the finger and the surface, and therefore to the force exerted by the finger. Measurements of amplitude, power, or energy of the sound can be compared to each other, for a relative ranking of impact forces, or to those of sounds recorded during a calibration procedure, in order to determine absolute values of the force of impact.

By combining detected stimuli in two domains, such as a visual and auditory domain, the present invention provides improved reliability and performance in the detection, classification, and interpretation of input events for a virtual keyboard.

In addition, the present invention more accurately determines the force that the user's finger applies to a typing surface. Accurate measurement of the force of the user input is useful in several applications. In a typing keyboard, force information allows the invention to distinguish between an intentional keystroke, in which a finger strikes the typing surface with substantial force, and a finger that approaches the typing surface inadvertently, perhaps by moving in sympathy with a finger that produces an intentional keystroke. In a virtual piano keyboard, the force applied to a key can modulate the intensity of the sound that the virtual piano application emits. A similar concept can be applied to many other virtual instruments, such as drums or other percussion instruments, and to any other interaction device where the force of the interaction with the typing surface is of interest. For operations such as turning a device on or off, force information is useful as well, since requiring a certain amount of force to be exceeded before the device is turned on or off can prevent inadvertent switching of the device in question.

The present invention is able to classify and interpret detected input events according to the time and force of contact with the typing surface. In addition, the techniques of the present invention can be combined with other techniques for determining the location of an input event, so as to more effectively interpret location-sensitive input events, such as virtual keyboard presses. For example, location can be determined based on sound delays, as described in related U.S. patent application Ser. No. 10/115,357 for “Method and Apparatus for Approximating a Source Position of a Sound-Causing Event for Determining an Input Used in Operating an Electronic Device,” filed Apr. 2, 2002, the disclosure of which is incorporated herein by reference. In such a system, a number of microphones are used to determine both the location and exact time of contact on the typing surface that is hit by the finger.

The present invention can be applied in any context where user action is to be interpreted and can be sensed in two or more domains. For instance, the driver of a car may gesture with her right hand in an appropriate volume within the vehicle in order to turn on and off the radio, adjust its volume, change the temperature of the air conditioner, and the like. A surgeon in an operating room may command an x-ray emitter by tapping on a blank, sterile surface on which a keyboard pad is projected. A television viewer may snap his fingers to alert that a remote-control command is ensuing, and then sign with his fingers in the air the number of the desired channel, thereby commanding the television set to switch channels. A popup menu system or other virtual control may be activated only upon the concurrent visual and auditory detection of a gesture that generates a sound, thereby decreasing the likelihood that the virtual controller is activated inadvertently. For instance, the user could snap her fingers, or clap her hands once or a pre-specified number of times. In addition, the gesture, being interpreted through both sound and vision, can signal to the system which of the people in the room currently desires to “own” the virtual control, and is about to issue commands.

In general, the present invention determines the synchronization of stimuli in two or more domains, such as images and sounds, in order to detect, classify, and interpret gestures or actions made by users for the purpose of communication with electronic devices.

### BRIEF DESCRIPTION OF THE DRAWINGS

FIG. 1 depicts a system of detecting, classifying, and interpreting input events according to one embodiment of the present invention.

FIG. 2 depicts a physical embodiment of the present invention, wherein the microphone transducer is located at the bottom of the case of a PDA.

FIG. 3 is a flowchart depicting a method for practicing the present invention according to one embodiment.

FIG. 4 depicts an overall architecture of the present invention according to one embodiment.

FIG. 5 depicts an optical sensor according to one embodiment of the present invention.

FIG. 6 depicts an acoustic sensor according to one embodiment of the present invention.

FIG. 7 depicts sensor locations for an embodiment of the present invention.

FIG. 8 depicts a synchronizer according to one embodiment of the present invention.

FIG. 9 depicts a processor according to one embodiment of the present invention.

FIG. 10 depicts a calibration method according to one embodiment of the present invention.

FIG. 11 depicts an example of detecting sound amplitude for two key taps, according to one embodiment of the present invention.

FIG. 12 depicts an example of an apparatus for remotely controlling an appliance such as a television set.

The figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

For illustrative purposes, in the following description the invention is set forth as a scheme for combining visual and auditory stimuli in order to improve the reliability and accuracy of detected input events. However, one skilled in the art will recognize that the present invention can be used in connection with any two (or more) sensory domains, including but not limited to visual detection, auditory detection, touch sensing, mechanical manipulation, heat detection, capacitance detection, motion detection, beam interruption, and the like.

In addition, the implementations set forth herein describe the invention in the context of an input scheme for a personal digital assistant (PDA). However, one skilled in the art will recognize that the techniques of the present invention can be used in conjunction with any electronic device, including for example a cell phone, pager, laptop computer, electronic musical instrument, television set, any device in a vehicle, and the like. Furthermore, in the following descriptions, “fingers” and “styluses” are referred to interchangeably.

Architecture

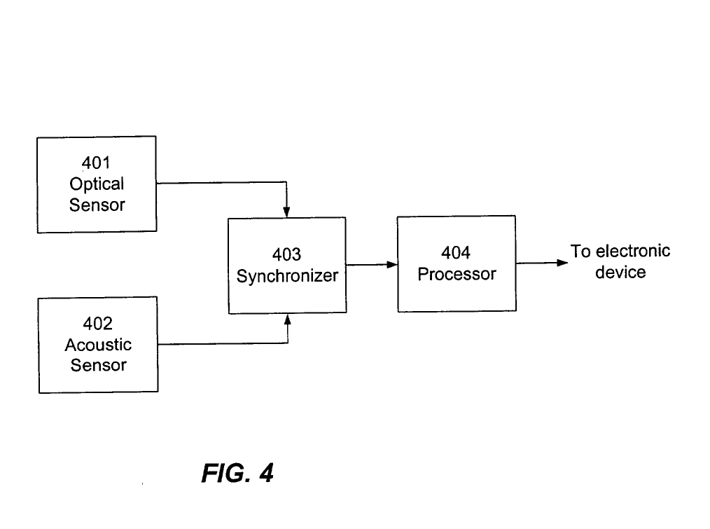

Referring now to FIG. 4, there is shown a block diagram depicting an overall architecture of the present invention according to one embodiment. The invention according to this architecture includes optical sensor 401, acoustic sensor 402, synchronizer 403, and processor 404. Optical sensor 401 collects visual information from the scene of interest, while acoustic sensor 402 records sounds carried through air or through another medium, such as a desktop, a whiteboard, or the like. Both sensors 401 and 402 convert their inputs to analog or digital electrical signals. Synchronizer 403 takes these signals and determines the time relationship between them, represented for example as the differences between the times at which optical and acoustic signals are recorded. Processor 404 processes the resulting time-stamped signals to produce commands that control an electronic device.

One skilled in the art will recognize that the various components of FIG. 4 are presented as functional elements that may be implemented in hardware, software, or any combination thereof. For example, synchronizer 403 and processor 404 could be different software elements running on the same computer, or they could be separate hardware units. Physically, the entire apparatus of FIG. 4 could be packaged into a single unit, or sensors 401 and 402 could be separate, located at different positions. Connections among the components of FIG. 4 may be implemented through cables or wireless connections. The components of FIG. 4 are described below in more detail and according to various embodiments.

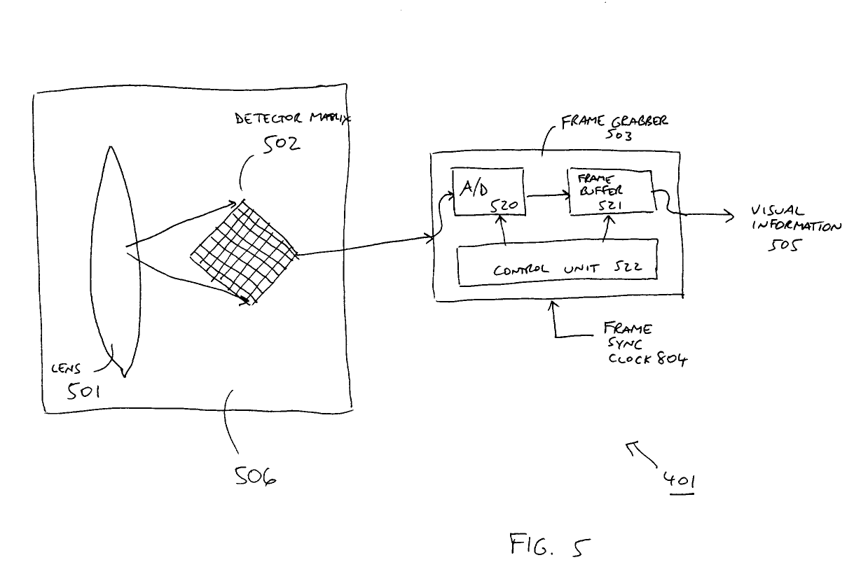

Referring now to FIG. 5, there is shown an embodiment of optical sensor 401. Optical sensor 401 may employ an electronic camera 506, including lens 501 and detector matrix 502, which operate according to well known techniques of image capture. Camera 506 sends signals to frame grabber 503, which outputs black-and-white or color images, either as an analog signal or as a stream of digital information. If the camera output is analog, an analog-to-digital converter 520 can be used optionally. In one embodiment, frame grabber 503 further includes frame buffer 521 for temporarily storing converted images, and control unit 522 for controlling the operation of A/D converter 520 and frame buffer 521.

Alternatively, optical sensor 401 may be implemented as any device that uses light to collect information about a scene. For instance, it may be implemented as a three-dimensional sensor, which computes the distance to points or objects in the world by measuring the time of flight of light, stereo triangulation from a pair or a set of cameras, laser range finding, structured light, or by any other means. The information output by such a three-dimensional device is often called a depth map.

Optical sensor 401, in one embodiment, outputs images or depth maps as visual information 505, either at a fixed or variable frame rate, or whenever instructed to do so by processor 404. Frame sync clock 804, which may be any clock signal provided according to well-known techniques, controls the frame rate at which frame grabber 503 captures information from matrix 502 to be transmitted as visual information 505.

In some circumstances, it may be useful to vary the frame rate over time. For instance, sensor 401 could be in a stand-by mode when little action is detected in the scene. In this mode, the camera acquires images with low frequency, perhaps to save power. As soon as an object or some interesting action is detected, the frame rate may be increased, in order to gather more detailed information about the events of interest.

One skilled in the art will recognize that the particular architecture and components shown in FIG. 5 are merely exemplary of a particular mode of image or depth map acquisition, and that optical sensor 401 can include any circuitry or mechanisms for capturing and transmitting images or depth maps to synchronizer 403 and processor 404. Such components may include, for example, signal conversion circuits, such as analog to digital converters, bus interfaces, buffers for temporary data storage, video cards, and the like.

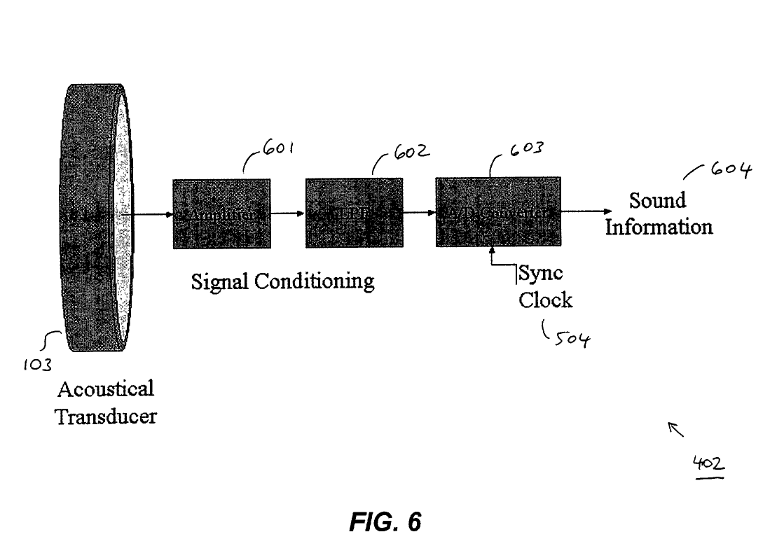

Referring now to FIG. 6, there is shown an embodiment of acoustic sensor 402. Acoustic sensor 402 includes transducer 103 that converts pressure waves or vibrations into electric signals, according to techniques that are well known in the art. In one embodiment, transducer 103 is an acoustic transducer such as a microphone, although one skilled in the art will recognize that transducer 103 may be implemented as a piezoelectric converter or other device for generating electric signals based on vibrations or sound.

In one embodiment, where taps on surface 50 are to be detected, transducer 103 is placed in intimate contact with surface 50, so that transducer 103 can better detect vibrations carried by surface 50 without excessive interference from other sounds carried by air. In one embodiment, transducer 103 is placed at or near the middle of the wider edge of surface 50. The placement of acoustic transducer 103 may also depend upon the location of camera 506 or upon other considerations and requirements.

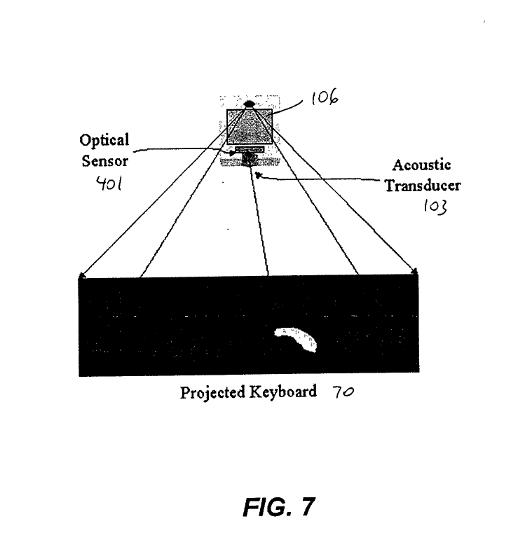

Referring now to FIG. 7, there is shown one example of locations of transducer 103 and optical sensor 401 with respect to projected keyboard 70, for a device such as PDA 106. One skilled in the art will recognize that other locations and placements of these various components may be used. In one embodiment, multiple transducers 103 are used, in order to further improve sound collection.

Referring again to FIG. 6, acoustic sensor 402 further includes additional components for processing sound or vibration signals for use by synchronizer 403 and processor 404. Amplifier 601 amplifies the signal received by transducer 103. Low-pass filter (LPF) 602 filters the signal to remove extraneous high-frequency components. Analog-to-digital converter 603 converts the analog signal to a digital sound information signal 604 that is provided to synchronizer 403. In one embodiment, converter 603 generates a series of digital packets, determined by the frame rate defined by sync clock 504. The components shown in FIG. 6, which operate according to well known techniques and principles of signal amplification, filtering, and processing, are merely exemplary of one implementation of sensor 402. Additional components, such as signal conversion circuits, bus interfaces, buffers, sound cards, and the like, may also be included.

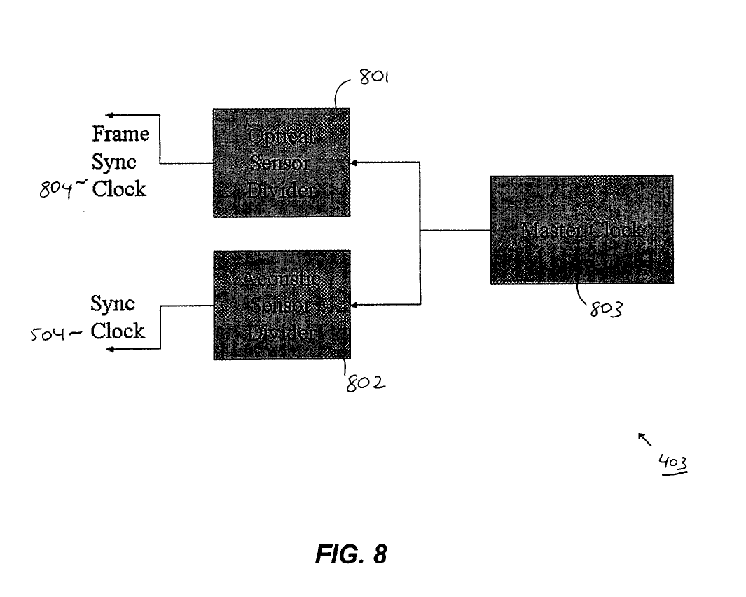

Referring now to FIG. 8, there is shown an embodiment of synchronizer 403 according to one embodiment. Synchronizer 403 provides functionality for determining and enforcing temporal relationships between optical and acoustic signals. Synchronizer 403 may be implemented as a software component or a hardware component. In one embodiment, synchronizer 403 is implemented as a circuit that includes electronic master clock 803, which generates numbered pulses at regular time intervals. Each pulse is associated with a time stamp, which in one embodiment is a progressive number that measures the number of oscillations of clock 803 starting from some point in time. Alternatively, time stamps may identify points in time by some other mechanism or scheme. In another embodiment, the time stamp indicates the number of image frames or the number of sound samples captured since some initial point in time. Since image frames are usually grabbed less frequently than sound samples, a sound-based time stamp generally provides a time reference with higher resolution than does an image-based time stamp. In many cases, the lower resolution of the latter time stamp is of sufficient resolution for purposes of the present invention.

In one mode of operation, synchronizer 403 issues commands that cause sensors 401 and/or 402 to grab image frames and/or sound samples. Accordingly, the output of synchronizer 403 is frame sync clock 804 and sync clock 504, which are used by frame grabber 503 of sensor 401 and A/D converter 603 of sensor 402, respectively. Synchronizer 403 commands may also cause a time stamp to be attached to each frame or sample. In an alternative embodiment, synchronizer 403 receives notification from sensors 401 and/or 402 that an image frame or a sound sample has been acquired, and attaches a time stamp to each.

In an alternative embodiment, synchronizer 403 is implemented in software. For example, frame grabber 503 may generate an interrupt whenever it captures a new image. This interrupt then causes a software routine to examine the computer's internal clock, and the time the latter returns is used as the time stamp for that frame. A similar procedure can be used for sound samples. In one embodiment, since the sound samples are usually acquired at a much higher rate than are image frames, the interrupt may be called only once every several sound samples. In one embodiment, synchronizer 403 allows for a certain degree of tolerance in determining whether events in two domains are synchronous. Thus, if the time stamps indicate that the events are within a predefined tolerance time period of one another, they are deemed to be synchronous. In one embodiment, the tolerance time period is 33 ms, which corresponds to a single frame period in a standard video camera.

In an alternative software implementation, the software generates signals that instruct optical sensor 401 and acoustic sensor 402 to capture frames and samples. In this case, the software routine that generates these signals can also consult the system clock, or alternatively it can stamp sound samples with the number of the image frame being grabbed in order to enforce synchronization. In one embodiment, optical sensor divider 801 and acoustic sensor divider 802 are either hardware circuitry or software routines. Dividers 801 and 802 count pulses from master clock 803, and output a synchronization pulse after every sequence of predetermined length of master-clock pulses. For instance, master clock 803 could output pulses at a rate of 1 MHz. If optical sensor divider 801 controls a standard frame grabber 503 that captures images at 30 frames per second, divider 801 would output one frame sync clock pulse 804 every 1,000,000/30≈33,333 master-clock pulses. If acoustic sensor 402 captures, say, 8,000 samples per second, acoustic sensor divider 802 would output one sync clock pulse 504 every 1,000,000/8,000=125 master clock pulses.

One skilled in the art will recognize that the above implementations are merely exemplary, and that synchronizer 403 may be implemented using any technique for providing information relating acquisition time of visual data with that of sound data.

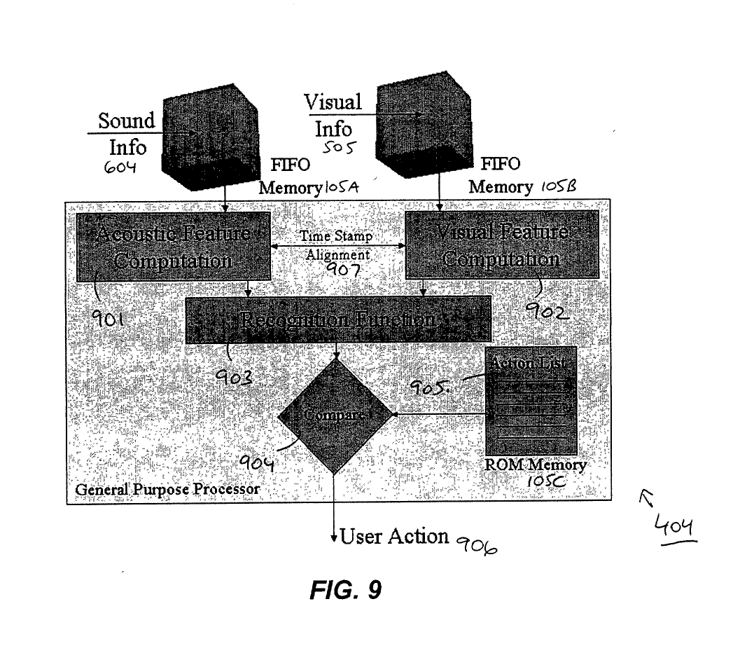

Referring now to FIG. 9, there is shown an example of an implementation of processor 404 according to one embodiment. Processor 404 may be implemented in software or in hardware, or in some combination thereof. Processor 404 may be implemented using components that are separate from other portions of the system, or it may share some or all components with other portions of the system. The various components and modules shown in FIG. 9 may be implemented, for example, as software routines, objects, modules, or the like.

Processor 404 receives sound information 604 and visual information 505, each including time stamp information provided by synchronizer 403. In one embodiment, portions of memory 105 are used as first-in first-out (FIFO) memory buffers 105A and 105B for audio and video data, respectively. As will be described below, processor 404 determines whether sound information 604 and visual information 505 concur in detecting occurrence of an intended user action of a predefined type that involves both visual and acoustic features.

In one embodiment, processor 404 determines concurrence by determining the simultaneity of the events recorded by the visual and acoustic channels, and the identity of the events. To determine simultaneity, processor 404 assigns a reference time stamp to each of the two information streams. The reference time stamp identifies a salient time in each stream; salient times are compared to the sampling times to determine simultaneity, as described in more detail below. Processor 404 determines the identity of acoustic and visual events, and the recognition of the underlying event, by analyzing features from both the visual and the acoustic source. The following paragraphs describe these operations in more detail.

Reference Time Stamps: User actions occur over extended periods of time. For instance, in typing, a finger approaches the typing surface at velocities that may approach 40 cm per second. The descent may take, for example, 100 milliseconds, which corresponds to 3 or 4 frames at 30 frames per second. Finger contact generates a sound towards the end of this image sequence. After landfall, sound propagates and reverberates in the typing surface for a time interval that may be on the order of 100 milliseconds. Reference time stamps identify an image frame and a sound sample that are likely to correspond to finger landfall, an event that can be reliably placed in time within each stream of information independently. For example, the vision reference time stamp can be computed by identifying the first image in which the finger reaches its lowest position. The sound reference time stamp can be assigned to the sound sample with the highest amplitude.

Simultaneity: Given two reference time stamps from vision and sound, simultaneity occurs if the two stamps differ by less than the greater of the sampling periods of the vision and sound information streams. For example, suppose that images are captured at 30 frames per second, and sounds at 8,000 samples per second, and let tᵥ and tₛ be the reference time stamps from vision and sound, respectively. Then the sampling periods are 33 milliseconds for vision and 125 microseconds for sound, and the two reference time stamps are simultaneous if |tᵥ−tₛ|≦33 ms.

Identity and Classification: Acoustic feature computation module 901 computes a vector a of acoustic features from a set of sound samples. Visual feature computation module 902 computes a vector v of visual features from a set of video samples. Action list 905, which may be stored in memory 105C as a portion of memory 105, describes a set of possible intended user actions. List 905 includes, for each action, a description of the parameters of an input corresponding to the user action. Processor 404 applies recognition function 903 rᵤ(a, v) for each user action u in list 905, and compares 904 the result to determine whether action u is deemed to have occurred.

For example, the visual feature vector v may include the height of the user's finger above the typing surface in, say, the five frames before the reference time stamp, and in the three frames thereafter, to form an eight-dimensional vector v=(v₁,K,v₈). Recognition function 903 could then compute estimates of finger velocity before and after posited landfall by averaging the finger heights in these frames. Vision postulates the occurrence of a finger tap if the downward velocity before the reference time stamp is greater than a predefined threshold, and the velocity after the reference time stamp is smaller than a different predefined threshold. Similarly, the vector a of acoustic features could be determined to support the occurrence of a finger tap if the intensity of the sound at the reference time stamp is greater than a predefined threshold. Mechanisms for determining this threshold are described in more detail below.

Signal 906 representing the particulars (or absence) of a user action, is transmitted to PDA 106 as an input to be interpreted as would any other input signal. One skilled in the art will recognize that the description of function 903 rᵤ(a, v) is merely exemplary. A software component may effectively perform the role of this function without being explicitly encapsulated in a separate routine.

In addition, processor 404 determines features of the user action that combine parameters that pertain to sound and images. For instance, processor 404 may use images to determine the speed of descent of a finger onto surface 50, and at the same time measure the energy of the sound produced by the impact, in order to determine that a quick, firm tap has been executed.

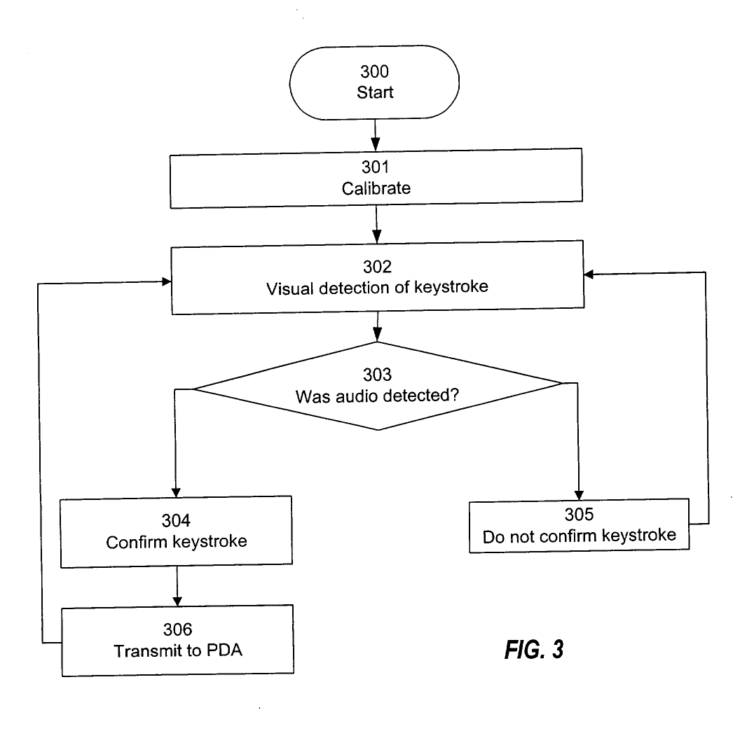

The present invention is capable of recognizing many different types of gestures, and of detecting and distinguishing among such gestures based on coincidence of visual and auditory stimuli. Detection mechanisms for different gestures may employ different recognition functions rᵤ(a, v). Additional embodiments for recognition function 903 rᵤ(a, v) and for different application scenarios are described in more detail below, in connection with FIG. 3.

Virtual Keyboard Implementation

The present invention may operate in conjunction with a virtual keyboard that is implemented according to known techniques or according to techniques set forth in the above-referenced related patents and application. As described above, such a virtual keyboard detects the location and approximate time of contact of the fingers with the typing surface, and informs a PDA or other device as to which key the user intended to press.

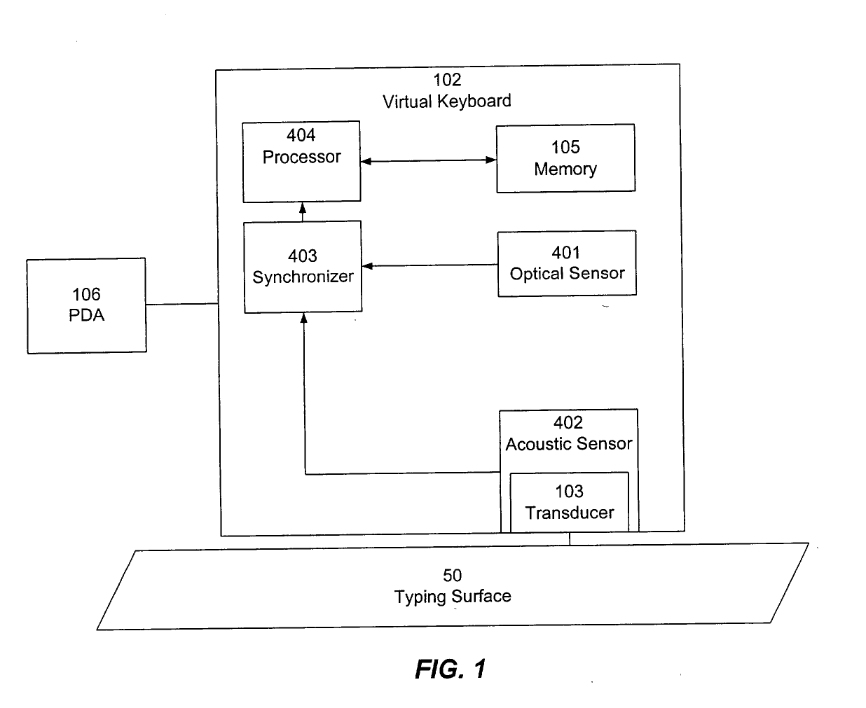

The present invention may be implemented, for example, as a sound-based detection system that is used in conjunction with a visual detection system. Referring now to FIG. 1, acoustic sensor 402 includes transducer 103 (e.g., a microphone). In one embodiment, acoustic sensor 402 includes a threshold comparator, using conventional analog techniques that are well known in the art. In an alternative embodiment, acoustic sensor 402 includes a digital signal processing unit such as a small microprocessor, to allow more complex comparisons to be performed. In one embodiment, transducer 103 is implemented for example as a membrane or piezoelectric element. Transducer 103 is intimately coupled with surface 50 on which the user is typing, so as to better pick up acoustic signals resulting from the typing.

Optical sensor 401 generates signals representing visual detection of user action, and provides such signals to processor 404 via synchronizer 403. Processor 404 interprets signals from optical sensor 401 and thereby determines which keys the user intended to strike, according to techniques described in related application “Method and Apparatus for Entering Data Using a Virtual Input Device,” referenced above. Processor 404 combines interpreted signals from sensors 401 and 402 to improve the reliability and accuracy of detected keystrokes, as described in more detail below. In one embodiment, the method steps of the present invention are performed by processor 404.

The components of the present invention are connected to or embedded in PDA 106 or some other device, to which the input collected by the present invention are supplied. Sensors 401 and 402 may be implemented as separate devices or components, or alternatively may be implemented within a single component. Flash memory 105, or some other storage device, may be provided for storing calibration information and for use as a buffer when needed. In one embodiment, flash memory 105 can be implemented using a portion of existing memory of PDA 106 or other device.

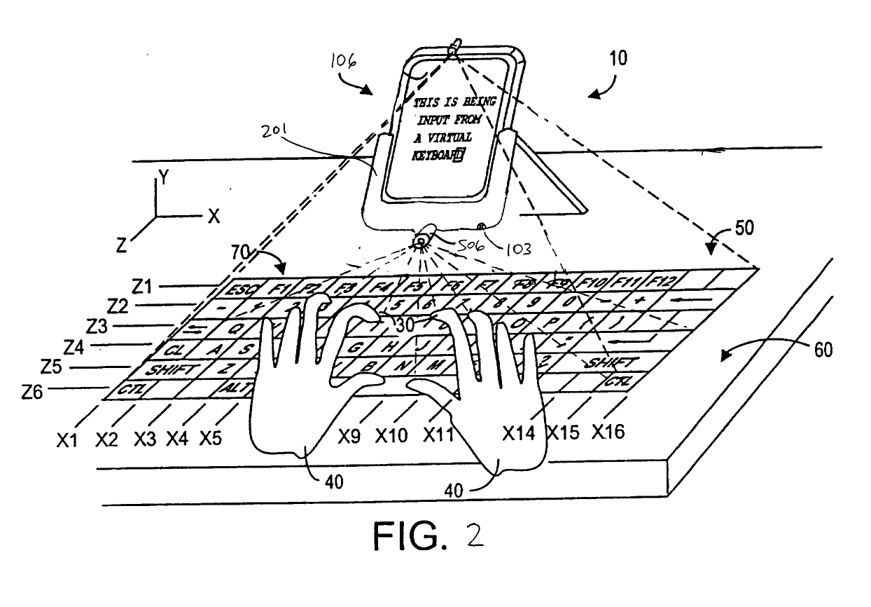

Referring now to FIG. 2, there is shown an example of a physical embodiment of the present invention, wherein microphone transducer 103 is located at the bottom of attachment 201 (such as a docking station or cradle) of a PDA 106. Alternatively, transducer 103 can be located at the bottom of PDA 106 itself, in which case attachment 201 may be omitted. FIG. 2 depicts a three-dimensional sensor system 10 comprising a camera 506 focused essentially edge-on towards the fingers 30 of a user's hands 40, as the fingers type on typing surface 50, shown here atop a desk or other work surface 60. In this example, typing surface 50 bears a printed or projected template 70 comprising lines or indicia representing a keyboard. As such, template 70 may have printed images of keyboard keys, as shown, but it is understood the keys are electronically passive, and are merely representations of real keys. Typing surface 50 is defined as lying in a Z-X plane in which various points along the X-axis relate to left-to-right column locations of keys, various points along the Z-axis relate to front-to-back row positions of keys, and Y-axis positions relate to vertical distances above the Z-X plane. It is understood that (X,Y,Z) locations are a continuum of vector positional points, and that various axis positions are definable in substantially more than the few number of points indicated in FIG. 2.

If desired, template 70 may simply contain row lines and column lines demarking where keys would be present. Typing surface 50 with template 70 printed or otherwise appearing thereon is a virtual input device that in the example shown emulates a keyboard. It is understood that the arrangement of keys need not be in a rectangular matrix as shown for ease of illustration in FIG. 2, but may be laid out in staggered or offset positions as in a conventional QWERTY keyboard. Additional description of the virtual keyboard system embodied in the example of FIG. 2 can be found in the related application for “Method and Apparatus for Entering Data Using a Virtual Input Device,” referenced above.

As depicted in FIG. 2, microphone transducer 103 is positioned at the bottom of attachment 201 (such as a docking station or cradle). In the example of FIG. 2, attachment 201 also houses the virtual keyboard system, including camera 506. The weight of PDA 106 and attachment 201 compresses a spring (not shown), which in turn pushes microphone transducer 103 against work surface 60, thereby ensuring a good mechanical coupling. Alternatively, or in addition, a ring of rubber, foam, or soft plastic (not shown) may surround microphone transducer 103, and isolate it from sound coming from the ambient air. With such an arrangement, microphone transducer 103 picks up mostly sounds that reach it through vibrations of work surface 60.

Method of Operation

Referring now to FIG. 3, there is shown a flowchart depicting a method for practicing the present invention according to one embodiment. When the system in accordance with the present invention is turned on, a calibration operation 301 is initiated. Such a calibration operation 301 can be activated after each startup, or after an initial startup when the user first uses the device, or when the system detects a change in the environment or surface that warrants recalibration, or upon user request.

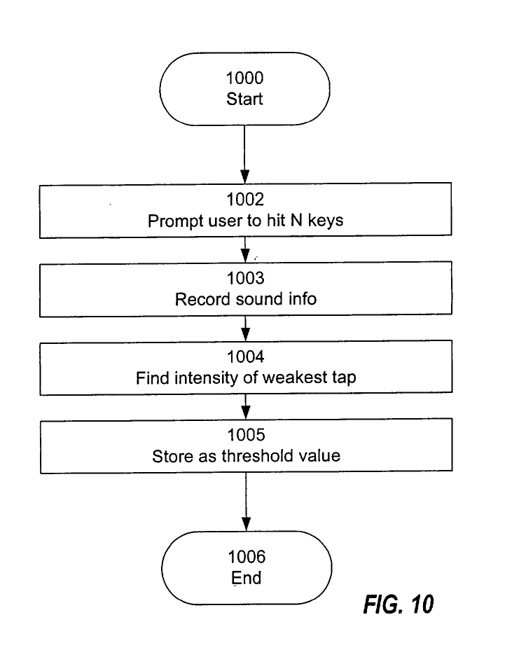

Referring momentarily to FIG. 10, there is shown an example of a calibration operation 301 according to one embodiment of the present invention. The system prompts 1002 the user to tap N keys for calibration purposes. The number of keys N may be predefined, or it may vary depending upon environmental conditions or other factors. The system then records 1003 the sound information as a set of N sound segments. In the course of a calibration operation, the sound-based detection system of the present invention learns properties of the sounds that characterize the user's taps. For instance, in one embodiment, the system measures 1004 the intensity of the weakest tap recorded during calibration, and stores it 1005 as a reference threshold level for determining whether or not a tap is intentional. In an alternative embodiment, the system stores (in memory 105, for example) samples of sound waveforms generated by the taps during calibration, or computes and stores a statistical summary of such waveforms. For example, it may compute an average intensity and a standard deviation around this average. It may also compute percentiles of amplitudes, power, or energy contents of the sample waveforms. Calibration operation 301 enables the system to distinguish between an intentional tap and other sounds, such as light, inadvertent contacts between fingers and the typing surface, or interfering ambient noises, such as the background drone of the engines on an airplane.

Referring again to FIG. 3, after calibration 301 if any, the system is ready to begin detecting sounds in conjunction with operation of virtual keyboard 102, using recognition function 903. Based on visual input v from optical sensor 401 recognition function 903 detects 302 that a finger has come in contact with typing surface 50. In general, however, visual input v only permits a determination of the time of contact to within the interval that separates two subsequent image frames collected by optical sensor 401. In typical implementations, this interval may be between 0.01 s and 0.1 s. Acoustic input a from acoustic sensor 402 is used to determine 303 whether a concurrent audio event was detected, and if so confirms 304 that the visually detected contact is indeed an intended keystroke. The signal representing the keystroke is then transmitted 306 to PDA 106. If in 303 acoustic sensor 402 does not detect a concurrent audio event, the visual event is deemed to not be a keystroke 305. In this manner, processor 404 is able to combine events sensed in the video and audio domains so as to be able to make more accurate determinations of the time of contact and the force of the contact.

In one embodiment, recognition function 903 determines 303 whether an audio event has taken place by measuring the amplitude of any sounds detected by transducer 103 during the frame interval in which optical sensor 401 observed contact of a finger with typing surface 50. If the measured amplitude exceeds that of the reference level, the keystroke is confirmed. The time of contact is reported as the time at which the reference level has been first exceeded within that frame interval. To inform optical sensor 401, processor 404 may cause an interrupt to optical sensor 401. The interrupt handling routine consults the internal clock of acoustic sensor 402, and stores the time into a register or memory location, for example in memory 105. In one embodiment, acoustic sensor 402 also reports the amount by which the measured waveform exceeded the threshold, and processor 404 may use this amount as an indication of the force of contact.

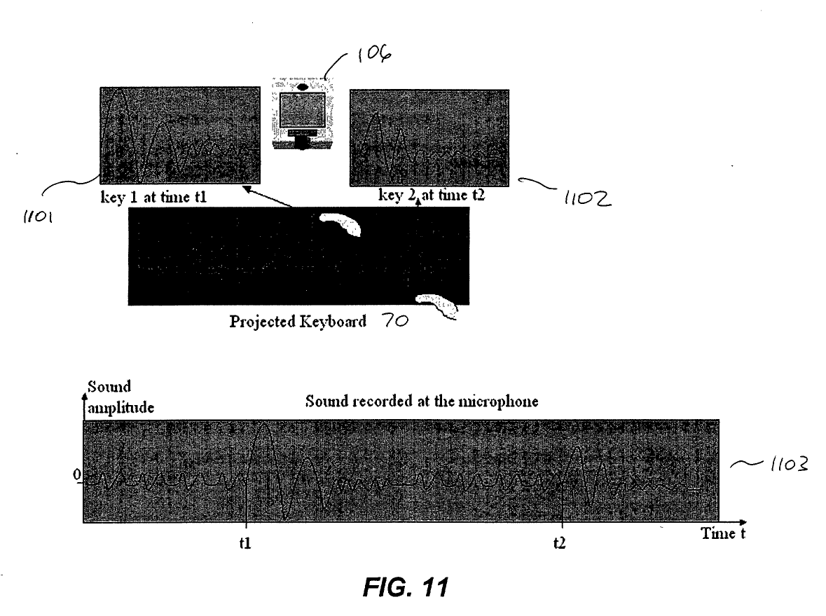

Referring momentarily to FIG. 11, there is shown an example of detected sound amplitude for two key taps. The graph depicts a representation of sound recorded by transducer 103. Waveforms detected at time t1 and t2 are extracted as possible key taps 1101 and 1102 on projected keyboard 70.

The above-described operation may be implemented as an analog sound-based detection system. In an alternative embodiment, acoustic sensor 402 is implemented using a digital sound-based detection system; such an implementation may be of particular value when a digital signal processing unit is available for other uses, such as for the optical sensor 401. The use of a digital sound-based detection system allows more sophisticated calculations to be used in determining whether an audio event has taken place; for example, a digital system may be used to reject interference from ambient sounds, or when a digital system is preferable to an analog one because of cost, reliability, or other reasons.

In a digital sound-based detection system, the voltage amplitudes generated by the transducer are sampled by an analog-to-digital conversion system. In one embodiment, the sampling frequency is between 1 kHz and 10 kHz although one skilled in the art will recognize that any sampling frequency may be used. In general, the frequency used in a digital sound-based detection system is much higher than the frame rate of optical sensor 401, which may be for example 10 to 100 frames per second. Incoming samples are either stored in memory 105, or matched immediately with the reference levels or waveform characteristics. In one embodiment, such waveform characteristics are in the form of a single threshold, or of a number of thresholds associated with different locations on typing surface 50. Processing then continues as described above for the analog sound-based detection system. Alternatively, the sound-based detection system may determine and store a time stamp with the newly recorded sound. In the latter case, processor 404 conveys time-stamp information to optical sensor 401 in response to a request by the latter.

In yet another embodiment, processor 404 compares an incoming waveform sample in detail with waveform samples recorded during calibration 301. Such comparison may be performed using correlation or convolution, in which the recorded waveform is used as a matched filter, according to techniques that are well known in the art. In such a method, if sₙ are the samples of the currently measured sound wave, and rₙ are those of a recorded wave, the convolution of sₙ and rₙ is defined as the following sequence of samples:

$${c}_{n} = {\sum }_{k = - ∞}^{∞} {s}_{n - k} {r}_{k} .$$

A match between the two waveforms sₙ and rₙ is then declared when the convolution cₙ reaches a predefined threshold. Other measures of correlation are possible, and well known in the art. The sum of squared differences is another example:

$${d}_{n} = {\sum }_{k = n - K}^{n} {( {s}_{k} - {r}_{k} )}^{2} ,$$

where the two waveforms are compared over the last K samples. In this case, a match is declared if dₙ goes below a predefined threshold. In one embodiment, K is given a value between 10 and 1000.

The exact time of a keystroke is determined by the time at which the absolute value of the convolution cₙ reaches its maximum, or the time at which the sum of squared differences dₙ reaches its minimum.

Finally, the force of contact can be determined as

$${max}_{n} \frac{{\sum }_{k = - ∞}^{∞} {s}_{n - k} {r}_{k}}{{\sum }_{k = - ∞}^{∞} {r}_{k}^{2}} ,$$

or as any other (possibly normalized) measure of energy of the measured waveform, such as, for instance,

$$\frac{{\sum }_{k = - ∞}^{∞} {s}_{k}^{2}}{{\sum }_{k = - ∞}^{∞} {r}_{k}^{2}} .$$

Of course, in all of these formulas, the limits of summation are in practice restricted to finite values.

In one embodiment, sample values for the current sample are stored and retrieved from a digital signal processor or general processor RAM.

In some cases, if the virtual keyboard 102 is to be used on a restricted set of typing surfaces 60, it may be possible to determine an approximation to the expected values of the reference samples rₙ ahead of time, so that calibration 301 at usage time may not be necessary.

Gesture Recognition and Interpretation

For implementations involving virtual controls, such as a gesture-based remote control system, the low-level aspects of recognition function 903 are similar to those discussed above for a virtual keyboard. In particular, intensity thresholds can be used as an initial filter for sounds, matched filters and correlation measures can be used for the recognition of particular types of sounds, and synchronizer 403 determines the temporal correspondence between sound samples and images.

Processing of the images in a virtual control system may be more complex than for a virtual keyboard, since it is no longer sufficient to detect the presence of a finger in the vicinity of a surface. Here, the visual component of recognition function 903 provides the ability to interpret a sequence of images as a finger snap or a clap of hands.

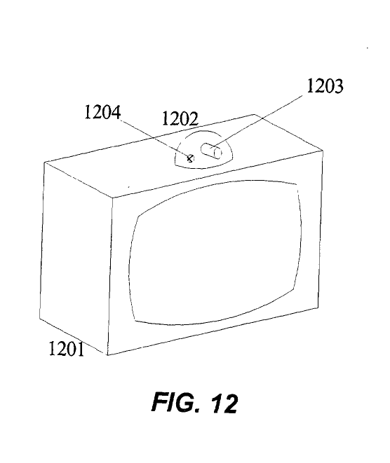

Referring now to FIG. 12, there is shown an example of an apparatus for remotely controlling an appliance such as a television set 1201. Audiovisual control unit 1202, located for example on top of television set 1201, includes camera 1203 (which could possibly also be a three-dimensional sensor) and microphone 1204. Inside unit 1202, a processor (not shown) analyzes images and sounds according to the diagram shown in FIG. 9. Visual feature computation module 902 detects the presence of one or two hands in the field of view of camera 1203 by, for example, searching for an image region whose color, size, and shape are consistent with those of one or two hands. In addition, the search for hand regions can be aided by initially storing images of the background into the memory of module 902, and looking for image pixels whose values differ from the stored values by more than a predetermined threshold. These pixels are likely to belong to regions where a new object has appeared, or in which an object is moving.

Once the hand region is found, a visual feature vector v is computed that encodes the shape of the hand's image. In one embodiment, v represents a histogram of the distances between random pairs of point in the contour of the hand region. In one embodiment, 100 to 500 point pairs are used to build a histogram with 10 to 30 bins.

Similar histograms v¹,K,v^{M} are pre-computed for M (ranging, in one embodiment, between 2 and 10) hand configurations of interest, corresponding to at most M different commands.

At operation time, reference time stamps are issued whenever the value of

$${min}_{m} ‖ v - {v}^{m} ‖$$

falls below a predetermined threshold, and reaches a minimum value over time. The value of m that achieves this minimum is the candidate gesture for the vision system.

Suppose now that at least some of the stored vectors v^{m} correspond to gestures emitting a sound, such as a snap of the fingers or a clap of hands. Then, acoustic feature computation module 901 determines the occurrence of, and reference time stamp for, a snap or clap event, according to the techniques described above.

Even if the acoustic feature computation module 901 or the visual feature computation module 902, working in isolation, would occasionally produce erroneous detection results, the present invention reduces such errors by checking whether both modules agree as to the time and nature of an event that involves both vision and sound. This is another instance of the improved recognition and interpretation that is achieved in the present invention by combining visual and auditory stimuli. In situations where detection in one or the other domain by itself is insufficient to reliably recognize a gesture, the combination of detection in two domains can markedly improve the rejection of unintended gestures.

The techniques of the present invention can also be used to interpret a user's gestures and commands that occur in concert with a word or brief phrase. For example, a user may make a pointing gesture with a finger or arm to indicate a desired direction or object, and may accompany the gesture with the utterance of a word like “here” or “there.” The phrase “come here” may be accompanied by a gesture that waves a hand towards one's body. The command “halt” can be accompanied by an open hand raised vertically, and “good bye” can be emphasized with a wave of the hand or a military salute.

For such commands that are simultaneously verbal and gestural, the present invention is able to improve upon conventional speech recognition techniques. Such techniques, although successful in limited applications, suffer from poor reliability in the presence of background noise, and are often confused by variations in speech patterns from one speaker to another (or even by the same speaker at different times). Similarly, as discussed above, the visual recognition of pointing gestures or other commands is often unreliable because intentional commands are hard to distinguish from unintentional motions, or movements made for different purposes.

Accordingly, the combination of stimulus detection in two domains, such as sound and vision, as set forth herein, provides improved reliability in interpreting user gestures when they are accompanied by words or phrases. Detected stimuli in the two domains are temporally matched in order to classify an input event as intentional, according to techniques described above.

Recognition function 903 rᵤ(a, v) can use conventional methods for speech recognition as are known in the art, in order to interpret the acoustic input a, and can use conventional methods for gesture recognition, in order to interpret visual input v. In one embodiment, the invention determines a first probability value pₐ(u) that user command u has been issued, based on acoustic information a, and determines a second probability value pᵥ(u) that user command u has been issued, based on visual information v. The two sources of information, measured as probabilities, are combined, for example by computing the overall probability that user command u has been issued:

p=1−(1−pₐ(u))(1−pᵥ(u))

p is an estimate of the probability that both vision and hearing agree that the user intentionally issued gesture u. It will be recognized that if pₐ(u) and pᵥ(u) are probabilities, and therefore numbers between 0 and 1, then p is a probability as well, and is a monotonically increasing function of both pₐ(u) and pᵥ(u). Thus, the interpretation of p as an estimate of a probability is mathematically consistent.

For example, in the example discussed with reference to FIG. 12, the visual probability pᵥ(u) can be set to

pᵥ(u)=Kᵥe^{-(v-v}^{^{m}}⁾^{²}

where Kᵥ is a normalization constant. The acoustic probability can be set to

pᵥ(u)=Kₐe^{-α}^{²}

where Kₐ is a normalization constant, and α is the amplitude of the sound recorded at the time of the acoustic reference time stamp.

In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatuses to perform the required method steps. The required structure for a variety of these systems appears from the description. In addition, the present invention is not described with reference to any particular programming language. It will be appreciated that a variety of programming languages may be used to implement the teachings of the invention as described herein.

The present invention improves reliability and performance in detecting, classifying, and interpreting user actions, by combining detected stimuli in two domains, such as for example visual and auditory domains. One skilled in the art will recognize that the particular examples described herein are merely exemplary, and that other arrangements, methods, architectures, and configurations may be implemented without departing from the essential characteristics of the present invention. Accordingly, the disclosure of the present invention is intended to be illustrative, but not limiting, of the scope of the invention, which is set forth in the following claims.

What is claimed is:

1. A computer-implemented method for classifying an input event, the method comprising:
receiving, at a visual sensor, a first stimulus resulting from user action, in a visual domain;
receiving, at an auditory sensor, a second stimulus resulting from user action, in an auditory domain; and
responsive to the first and second stimuli indicating substantial simultaneity of the corresponding user action, classifying the stimuli as associated with a single user input event.

2. A computer-implemented method for classifying an input event, comprising:
receiving a first stimulus, resulting from user action, in a visual domain;
receiving a second stimulus, resulting from user action, in an auditory domain;
classifying the first stimulus according to at least a time of occurrence;
classifying the second stimulus according to at least a time of occurrence; and
responsive to the classifying steps indicating substantial simultaneity of the first and second stimuli, classifying the stimuli as associated with a single user input event.

3. The method of claim 2, wherein:
classifying the first stimulus comprises determining a time for the corresponding user action; and
classifying the second stimulus comprises determining a time for the corresponding user action.

4. The method of claim 3, wherein:
determining a time comprises reading a time stamp.

5. The method of claim 1 or 2, further comprising:
generating a vector of visual features based on the first stimulus;
generating a vector of acoustic features based on the second stimulus;
comparing the generated vectors to user action descriptors for a plurality of user actions; and
responsive to the comparison indicating a match, outputting a signal indicating a recognized user action.

6. The method of claim 1 or 2, wherein the single user input event comprises a keystroke.

7. The method of claim 1 or 2, wherein each user action comprises a physical gesture.

8. The method of claim 1 or 2, wherein each user action comprises at least one virtual key press.

9. The method of claim 1 or 2, wherein receiving a first stimulus comprises receiving a stimulus at a camera.

10. The method of claim 1 or 2, wherein receiving a second stimulus comprises receiving a stimulus at a microphone.

11. The method of claim 1 or 2, further comprising:
determining a series of waveform signals from the received second stimulus; and
comparing the waveform signals to at least one predetermined waveform sample to determine occurrence and time of at least one auditory event.

12. The method of claim 1 or 2, further comprising:
determining a series of sound intensity values from the received second stimulus; and
comparing the sound intensity values with at a threshold value to determine occurrence and time of at least one auditory event.

13. The method of claim 1 or 2, wherein receiving a second stimulus comprises receiving an acoustic stimulus representing a user's taps on a surface.

14. The method of claim 1 or 2, further comprising:
responsive to the stimuli being classified as associated with a single user input event, transmitting a command associated with the user input event.

15. The method of claim 1 or 2, further comprising:
determining a metric measuring relative force of the user action; and
generating a parameter for the user input event based on the determined force metric.

16. The method of claim 1 or 2, further comprising transmitting the classified input event to one selected from the group consisting of:
a computer;
a handheld computer;
a personal digital assistant;
a musical instrument; and
a remote control.

17. The method of claim 1, further comprising:
for each received stimulus, determining a probability that the stimulus represents an intended user action; and
combining the determined probabilities to determine an overall probability that the received stimuli collectively represent a single intended user action.

18. The method of claim 1, further comprising:
for each received stimulus, determining a time for the corresponding user action; and
comparing the determined time to determine whether the first and second stimuli indicate substantial simultaneity of the corresponding user action.

19. The method of claim 1, further comprising:
for each received stimulus, reading a time stamp indicating a time for the corresponding user action; and
comparing the time stamps to determine whether the first and second stimuli indicate substantial simultaneity of the corresponding user action.

20. A computer-implemented method for filtering input events, comprising:
detecting, in a visual domain, a first plurality of input events resulting from user action;
detecting, in an auditory domain, a second plurality of input events resulting from user action;
for each detected event in the first plurality:
determining whether the detected event in the first plurality corresponds to a detected event in the second plurality; and
responsive to the detected event in the first plurality not corresponding to a detected event in the second plurality, filtering out the event in the first plurality.

21. The method of claim 20, wherein determining whether the detected event in the first plurality corresponds to a detected event in the second plurality comprises:
determining whether the detected event in the first plurality and the detected event in the second plurality occurred substantially simultaneously.

22. The method of claim 20, wherein determining whether the detected event in the first plurality corresponds to a detected event in the second plurality comprises:
determining whether the detected event in the first plurality and the detected event in the second plurality respectively indicate substantially simultaneous user actions.

23. The method of claim 20, wherein each user action comprises at least one physical gesture.

24. The method of claim 20, wherein each user action comprises at least one virtual key press.

25. The method of claim 20, wherein detecting a first plurality of input events comprises receiving signals from a camera.

26. The method of claim 20, wherein detecting a second plurality of input events comprises receiving signals from a microphone.

27. The method of claim 20, further comprising, for each detected event in the first plurality:
responsive to the event not being filtered out, transmitting a command associated with the event.

28. The method of claim 27, further comprising, responsive to the event not being filtered out:
determining a metric measuring relative force of the user action; and
generating a parameter for the command based on the determined force metric.

29. The method of claim 20, wherein determining whether the detected event in the first plurality corresponds to a detected event in the second plurality comprises:
determining whether a time stamp for the detected event in the first plurality indicates substantially the same time as a time stamp for the detected event in the second plurality.

30. A computer-implemented method for classifying an input event, comprising:
receiving a visual stimulus, resulting from user action, in a visual domain;
receiving an acoustic stimulus, resulting from user action, in an auditory domain; and
generating a vector of visual features based on the received visual stimulus;
generating a vector of acoustic features based on the received acoustic stimulus;
comparing the generated vectors to user action descriptors for a plurality of user actions; and
responsive to the comparison indicating a match, outputting a signal indicating a recognized user action.

31. A system for classifying an input event, comprising:
an optical sensor, for receiving an optical stimulus resulting from user action, in a visual domain, and for generating a first signal representing the optical stimulus;
an acoustic sensor, for receiving an acoustic stimulus resulting from user action, in an auditory domain, and for generating a second signal representing the acoustic stimulus; and
a synchronizer, coupled to receive the first signal from the optical sensor and the second signal from the acoustic sensor, for determining whether the received signals indicate substantial simultaneity of the corresponding user action, and responsive to the determination, classifying the signals as associated with a single user input event.

32. The system of claim 31, wherein the user action comprises at least one keystroke.

33. The system of claim 31, wherein the user action comprises at least one physical gesture.

34. The system of claim 31, further comprising:
a virtual keyboard, positioned to guide user actions to result in stimuli detectable by the optical and acoustic sensors;
wherein a user action comprises a key press on the virtual keyboard.

35. The system of claim 31, wherein the optical sensor comprises a camera.

36. The system of claim 31, wherein the acoustic sensor comprises a transducer.

37. The system of claim 31, wherein the acoustic sensor generates at least one waveform signal representing the second stimulus, the system further comprising:
a processor, coupled to the synchronizer, for comparing the at least one waveform signal with at least one predetermined waveform sample to determining occurrence and time of at least one auditory event.

38. The system of claim 31, wherein the acoustic sensor generates at least one waveform intensity value representing the second stimulus, the system further comprising:
a processor, coupled to the synchronizer, for comparing the at least one waveform intensity value with at least one predetermined threshold value to determining occurrence and time of at least one auditory event.

39. The system of claim 31, further comprising:
a surface for receiving a user's taps;
wherein the acoustic sensor receives an acoustic stimulus representing the user's taps on the surface.

40. The system of claim 31, further comprising:
a processor, coupled to the synchronizer, for, responsive to the stimuli being classified as associated with a single user input event, transmitting a command associated with the user input event.

41. The system of claim 31, wherein the processor:
determines a metric measuring relative force of the user action; and
generates a parameter for the command based on the determined force metric.

42. The system of claim 31, further comprising:
a processor, coupled to the synchronizer, for:
for each received stimulus, determining a probability that the stimulus represents an intended user action; and
combining the determined probabilities to determine an overall probability that the received stimuli collectively represent an intended user action.

43. The system of claim 31, wherein the synchronizer:
for each received stimulus, determines a time for the corresponding user action; and
compares the determined time to determine whether the optical and acoustic stimuli indicate substantial simultaneity of the corresponding user action.

44. The system of claim 31, wherein the synchronizer:
for each received stimulus, reads a time stamp indicating a time for the corresponding user action; and
compares the read time stamps to determine whether the optical and acoustic stimuli indicate substantial simultaneity of the corresponding user action.

45. The system of claim 31, further comprising:
a processor, coupled to the synchronizer, for identifying an intended user action, the processor comprising:
a visual feature computation module, for generating a vector of visual features based on the received optical stimulus;
an acoustic feature computation module, for generating a vector of acoustic features based on the received acoustic stimulus;
an action list containing descriptors of a plurality of user actions; and
a recognition function, coupled to the feature computation modules and to the action list, for comparing the generated vectors to the user action descriptors.

46. The system of claim 31, wherein the user input event corresponds to input for a device selected from the group consisting of:
a computer;
a handheld computer;
a personal digital assistant;
a musical instrument; and
a remote control.

47. A computer program product for classifying an input event, the computer program product comprising:
a computer readable medium; and
computer program instructions, encoded on the medium, for controlling a processor to perform the operations of:
receiving, at a visual sensor, a first stimulus resulting from user action, in a visual domain;
receiving, at an auditory sensor, a second stimulus resulting from user action, in an auditory domain; and
responsive to the first and second stimuli indicating substantial simultaneity of the corresponding user action, classifying the stimuli as associated with a single user input event.

48. A computer program product for classifying an input event, the computer program product comprising:
a computer readable medium; and
computer program instructions, encoded on the medium, for controlling a processor to perform the operations of:
receiving a first stimulus, resulting from user action, in a visual domain;
receiving a second stimulus, resulting from user action, in an auditory domain;
classifying the first stimulus according to at least a time of occurrence;
classifying the second stimulus according to at least a time of occurrence; and
responsive to the classifying steps indicating substantial simultaneity of the first and second stimuli, classifying the stimuli as associated with a single user input event.

49. The computer program product of claim 48, wherein:
classifying the first stimulus comprises determining a time for the corresponding user action; and
classifying the second stimulus comprises determining a time for the corresponding user action.

50. The computer program product of claim 49, wherein:
determining a time comprises reading a time stamp.

51. The computer program product of claim 47 or 48, further comprising computer program instructions, encoded on the medium, for controlling a processor to perform the operations of:
generating a vector of visual features based on the first stimulus;
generating a vector of acoustic features based on the second stimulus;
comparing the generated vectors to user action descriptors for a plurality of user actions; and
responsive to the comparison indicating a match, outputting a signal indicating a recognized user action.

52. The computer program product of claim 47 or 48, wherein the single user input event comprises a keystroke.

53. The computer program product of claim 47 or 48, wherein each user action comprises a physical gesture.

54. The computer program product of claim 47 or 48, wherein each user action comprises at least one virtual key press.

55. The computer program product of claim 47 or 48, wherein receiving a first stimulus comprises receiving a stimulus at a camera.

56. The computer program product of claim 47 or 48, wherein receiving a second stimulus comprises receiving a stimulus at a microphone.

57. The computer program product of claim 47 or 48, further comprising computer program instructions, encoded on the medium, for controlling a processor to perform the operations of:
determining a series of waveform signals from the received second stimulus; and
comparing the waveform signals to at least one predetermined waveform sample to determine occurrence and time of at least one auditory event.

58. The computer program product of claim 47 or 48, further comprising computer program instructions, encoded on the medium, for controlling a processor to perform the operations of:
determining a series of sound intensity values from the received second stimulus; and
comparing the sound intensity values with at a threshold value to determine occurrence and time of at least one auditory event.

59. The computer program product of claim 47 or 48, wherein receiving a second stimulus comprises receiving an acoustic stimulus representing a user's taps on a surface.

60. The computer program product of claim 47 or 48, further comprising computer program instructions, encoded on the medium, for controlling a processor to perform the operation of:
responsive to the stimuli being classified as associated with a single user input event, transmitting a command associated with the user input event.

61. The computer program product of claim 47 or 48, further comprising computer program instructions, encoded on the medium, for controlling a processor to perform the operations of:
determining a metric measuring relative force of the user action; and
generating a parameter for the user input event based on the determined force metric.

62. The computer program product of claim 47 or 48, further comprising computer program instructions, encoded on the medium, for controlling a processor to perform the operation of transmitting the classified input event to one selected from the group consisting of:
a computer;
a handheld computer;
a personal digital assistant;
a musical instrument; and
a remote control.

63. The computer program product of claim 47, further comprising computer program instructions, encoded on the medium, for controlling a processor to perform the operations of:
for each received stimulus, determining a probability that the stimulus represents an intended user action; and
combining the determined probabilities to determine an overall probability that the received stimuli collectively represent a single intended user action.

64. The computer program product of claim 47, further comprising computer program instructions, encoded on the medium, for controlling a processor to perform the operations of:
for each received stimulus, determining a time for the corresponding user action; and
comparing the determined time to determine whether the first and second stimuli indicate substantial simultaneity of the corresponding user action.

65. The computer program product of claim 47, further comprising computer program instructions, encoded on the medium, for controlling a processor to perform the operations of:
for each received stimulus, reading a time stamp indicating a time for the corresponding user action; and
comparing the time stamps to determine whether the first and second stimuli indicate substantial simultaneity of the corresponding user action.

66. A computer program product for filtering input events, the computer program product comprising:
a computer readable medium; and
computer program instructions, encoded on the medium, for controlling a processor to perform the operations of:
detecting, in a visual domain, a first plurality of input events resulting from user action;
detecting, in an auditory domain, a second plurality of input events resulting from user action;
for each detected event in the first plurality:
determining whether the detected event in the first plurality corresponds to a detected event in the second plurality; and
responsive to the detected event in the first plurality not corresponding to a detected event in the second plurality, filtering out the event in the first plurality.

67. The computer program product of claim 66, wherein determining whether the detected event in the first plurality corresponds to a detected event in the second plurality comprises:
determining whether the detected event in the first plurality and the detected event in the second plurality occurred substantially simultaneously.

68. The computer program product of claim 66, wherein determining whether the detected event in the first plurality corresponds to a detected event in the second plurality comprises:
determining whether the detected event in the first plurality and the detected event in the second plurality respectively indicate substantially simultaneous user actions.

69. The computer program product of claim 66, wherein each user action comprises at least one physical gesture.

70. The computer program product of claim 66, wherein each user action comprises at least one virtual key press.

71. The computer program product of claim 66, wherein detecting a first plurality of input events comprises receiving signals from a camera.

72. The computer program product of claim 66, wherein detecting a second plurality of input events comprises receiving signals from a microphone.

73. The computer program product of claim 66, further comprising computer program instructions, encoded on the medium, for controlling a processor to perform the operation of, for each detected event in the first plurality:
responsive to the event not being filtered out, transmitting a command associated with the event.

74. The computer program product of claim 73, further comprising computer program instructions, encoded on the medium, for controlling a processor to perform the operations of, responsive to the event not being filtered out:
determining a metric measuring relative force of the user action; and
generating a parameter for the command based on the determined force metric.

75. The computer program product of claim 66, wherein determining whether the detected event in the first plurality corresponds to a detected event in the second plurality comprises:
determining whether a time stamp for the detected event in the first plurality indicates substantially the same time as a time stamp for the detected event in the second plurality.

76. A computer program product for classifying an input event, the computer program product comprising:
a computer readable medium; and
computer program instructions, encoded on the medium, for controlling a processor to perform the operations of:
receiving a visual stimulus, resulting from user action, in a visual domain;
receiving an acoustic stimulus, resulting from user action, in an auditory domain; and
generating a vector of visual features based on the received visual stimulus;
generating a vector of acoustic features based on the received acoustic stimulus;
comparing the generated vectors to user action descriptors for a plurality of user actions; and
responsive to the comparison indicating a match, outputting a signal indicating a recognized user action.
